(19) United States
(12) Patent Application Publication
(10) Pub. No.: US 2005/0027779 A1
(43) Pub. Date: Feb. 3, 2005

(54) System and method for organizing email messages

(76) Inventor: Charles Edward Schinner, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,932

(22) Filed: Jul. 29, 2003

(51) Int. Cl. G06F 15/16

(52) U.S. Cl. 709/200

(57) ABSTRACT

Disclosed are systems and methods for organizing email messages. In one embodiment, a system and a method pertain to detecting receipt of email messages, determining if the received email messages identify a recipient to which an original email message was transmitted by the user, and organizing responsive content from at least two independent received email messages in a consolidated file such that responsive content that pertains to a given email exchange is contained within a single file.

### BACKGROUND

Electronic mail, or “email,” has made it easier than ever to communicate with other people. Although simplifying communication in some respects, email complicates our communication in others. For instance, when someone emails a group of individuals, particularly a large number of individuals, the reply email messages received from those individuals can be difficult to manage, especially when the recipients reply to each others' replies.

To cite an example, assume person A sends an email message to ten different individuals. If the person A receives replies from each of the individuals, person A will then have ten email messages in his or her “inbox” to review. Assume further that one or more of the individuals respond using a “reply to all” feature of their email programs such that each of the other individuals also receives at least one reply email message. If one or more of the individuals that receive those reply email messages then reply and also transmit the reply to “all,” person A will further receive each of those email messages. As this practice is repeated, person A's inbox may become inundated with email messages. In addition to simply reviewing the emails, person A will need to determine who is responding to whom if person A is to understand the context of the communications in the online “conversation.” 1.

From the above, it can be appreciated that it would be desirable to have a system and method for organizing email messages received from multiple recipients in a given email exchange.

### SUMMARY

Disclosed are systems and methods for organizing email messages. In one embodiment, a system and a method pertain to detecting receipt of email messages, determining if the received email messages identify a recipient to which an original email message was transmitted by the user, and organizing responsive content from at least two independent received email messages in a consolidated file such that responsive content that pertains to a given email exchange is contained within a single file.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system in which email messages can be transmitted between multiple users.

FIG. 2 is a block diagram of a computing device shown in FIG. 1.

FIG. 3 is a flow diagram that illustrates an example embodiment of a method for organizing email messages.

FIGS. 4A-4D are example email messages that are received as replies to an original outgoing email message transmitted by a user.

FIG. 5 is an embodiment of a first consolidated email message that contains content of the email messages of FIGS. 4A-4D.

FIG. 6 is an embodiment of a second consolidated email message that contains content of the email messages of FIGS. 4A-4D and new responsive content.

FIG. 7 is a flow diagram that summarizes an embodiment of a method for organizing email messages.

### DETAILED DESCRIPTION

As described above, it can be difficult to manage multiple received email messages that pertain to an initial email message that was transmitted. Disclosed herein are systems and methods that organize such received email messages to aid the user in managing those messages. In some embodiments, the systems and methods consolidate the received email messages into a single email message, or other file, in a predetermined order. In such a case, the user can access all correspondence pertinent to a given email exchange from a single location and can more easily track the online “conversation” that has occurred.

Example systems and methods are discussed with reference to the figures.

Although these systems and methods are described in detail, they are provided for purposes of illustration only. Therefore, various modifications are feasible.

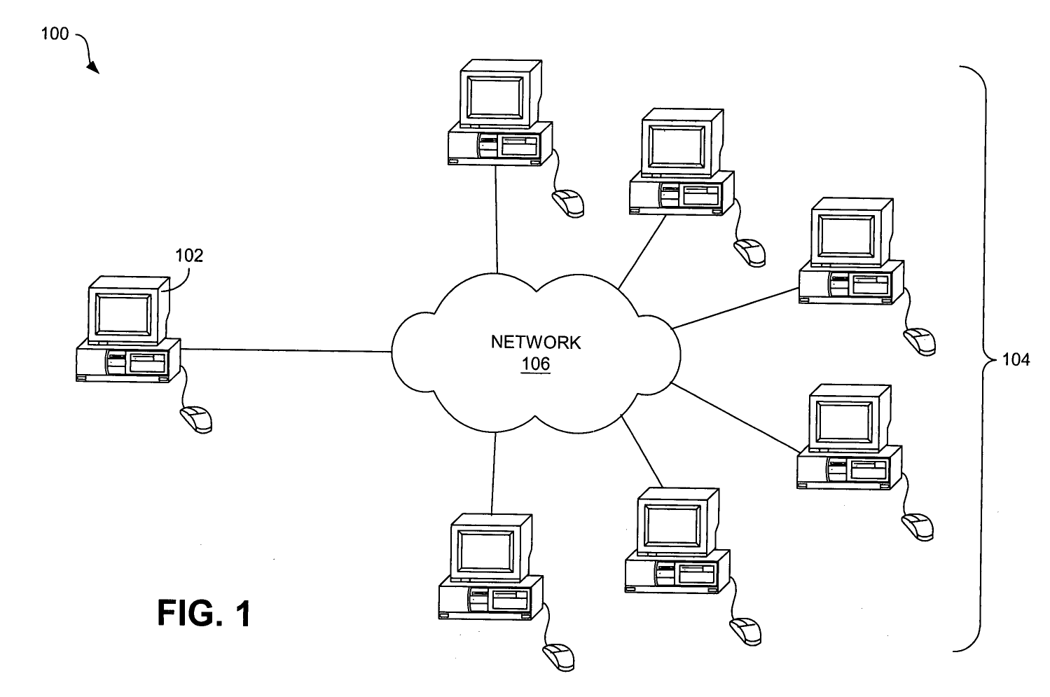

Referring now in more detail to the drawings, in which like numerals indicate corresponding parts throughout the several views, FIG. 1 illustrates an example system 100. As indicated in this figure, the system 100 generally comprises a first computing device 102 and one or more other computing devices 104, each of which is connected to a network 106.

The first computing device 102 comprises substantially any device that is capable of transmitting email messages to the other computing devices 104 as well as receiving email messages from the other computing devices. As is illustrated in FIG. 1, the first computing device 102 can comprise a personal computer (PC). Although a PC is shown in FIG. 1 and has been explicitly identified herein, the first computing device 102 can, alternatively, comprise another type of computing device including, for instance, a notebook computer, a personal digital assistant (PDA), a mobile telephone, or a pager. Notably, the other computing devices 104 can have configurations similar to that of the first computing device 102.

The network 106 typically comprises one or more sub-networks that are communicatively coupled to each other. By way of example, these networks can include one or more local area networks (LANs) an/or wide area networks (WANs).

In some embodiments, the network 106 may comprise a set of networks that forms part of the Internet. The first computing device 102, as well as the other computing devices 104, can communicate over the network 106 via either a wired or wireless (e.g., radio frequency (RF)) connection.

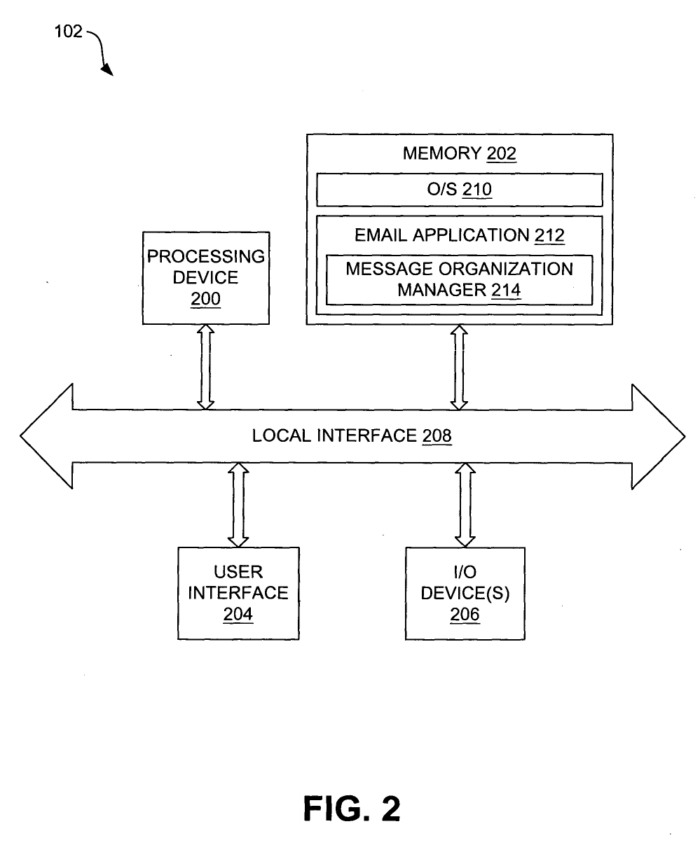

FIG. 2 is a schematic view illustrating an example architecture for the first computing device 102 shown in FIG. 1. As indicated in FIG. 2, the first computing device 102 comprises a processing device 200, memory 202, a user interface 204, and one or more input/output (I/O) devices 206, each of which is connected to a local interface 208.

The processing device 200 can include a general-purpose processor, a microprocessor, one or more application-specific integrated circuits (ASICs), a plurality of suitably configured digital logic gates, or other electrical configurations comprised of discrete elements that coordinate the overall operation of the first computing device 102.

The memory 202 includes any one of a combination of volatile memory elements (e.g., random access memory (RAM)) and nonvolatile memory elements (e.g., hard disk, read only memory, (ROM), Flash memory).

The user interface 204 comprises the components with which the user can interact with the first computing device 102. For example, where the computing device 102 comprises a PC or notebook computer, these components can comprise, for instance, a keyboard, mouse, and a display. Where the computing device 102 comprises a handheld device (e.g., PDA, mobile telephone, pager), these components can comprise, for instance, function keys or buttons and, optionally, a touch-sensitive screen.

With further reference to FIG. 2, the one or more I/O devices 206 comprise components that are adapted to facilitate connection of the first computing device 102 to another device and may therefore include one or more serial, parallel, small computer system interface (SCSI), universal serial bus (USB), IEEE 1394 (e.g., Firewire™), or other communication components. In addition, the I/O devices 206 comprise the various components used to transmit and/or receive data over the network 106. By way of example, such components include one or more of a modulator/demodulator (e.g., modem), wireless (e.g., RF) transceiver, and/or a network card.

The memory 202 comprises various programs, in software and/or firmware, including an operating system (O/S) 210 and an email application 212. The O/S 210 controls the execution of other software and provides scheduling, input-output control, file and data management, memory management, and communication control and related services. The email application 212 facilitates the transmission and receipt of email messages and, as indicated in FIG. 2, comprises a message organization manager 214 that, as described below, is used to organize received email messages that pertain to a particular email exchange. In some embodiments, the message organization manager 214 is configured to consolidate at least portions of multiple received email messages into a single email message or other file to simplify review of the entire exchange.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can be used by or in connection with an instruction execution system, apparatus, or device, such as a computer-based system, processor-containing system, or other system that can fetch the instructions from the instruction execution system, apparatus, or device and execute the instructions.

Example systems having been described above, examples of system operation will now be discussed. In the discussions that follow, flow diagrams are provided.

Process steps or blocks in the flow diagrams of this disclosure may represent modules, segments, or portions of code that include one or more executable instructions for implementing specific logical functions or steps in the process. Although particular example process steps are described, alternative implementations are feasible.

Moreover, steps may be executed out of order from that shown or discussed, including substantially concurrently or in reverse order, depending on the functionality involved.

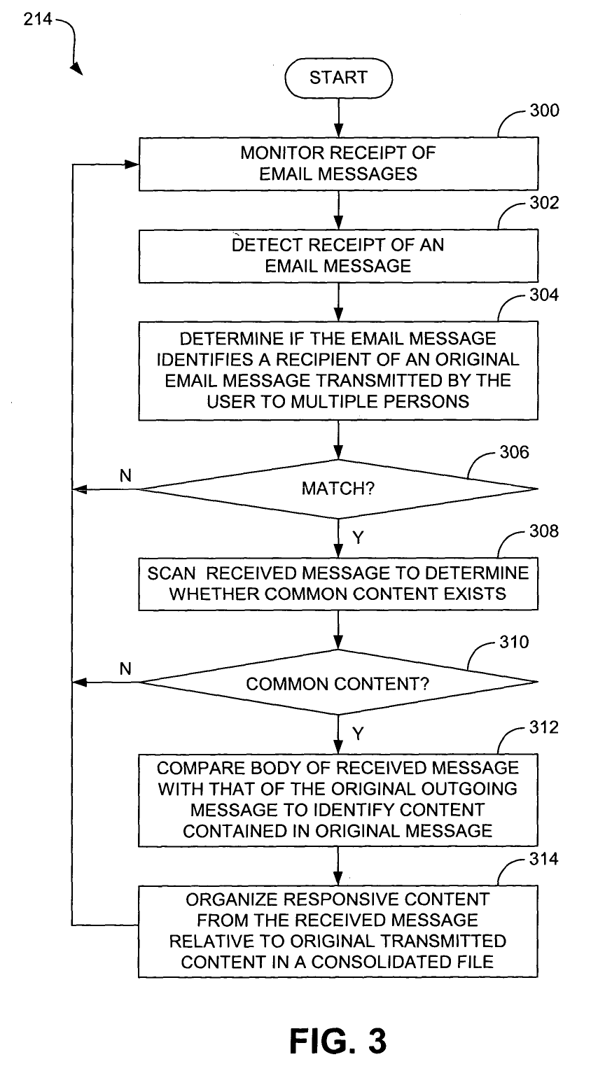

As described above, the disclosed systems can be used to organize received email messages to aid the user in managing those messages, especially when many reply emails are received from different persons in response to or that pertain to an outgoing email message that was transmitted by the user. FIG. 3 describes an example of such organization. More particularly, FIG. 3 describes an example of operation of the message organization manager 214 identified in FIG. 2 in consolidating responsive content from such reply email messages in a single message or other file.

Beginning with block 300 of FIG. 3, the message organization manager 214 monitors receipt of email messages. Such monitoring is facilitated by the fact that the organization manager 214 forms part of the email application 212 that executes on the computing device 102. If the message organization manager 214 were not integrated into the email application 212, however, such monitoring could be effected through implementation of an appropriate software module that is configured to conduct such monitoring of the communications received by the email application.

Due to the monitoring performed by the message organization manager 214, the manager can detect the receipt of an email message, as indicated in block 302. At this point, the message organization manager 214 determines whether the received email message is a candidate for the type of organization that the manager is configured to provide. Specifically, the manager 214 determines whether the email message is responsive to an original email message that the user transmitted. If so, the email message potentially forms part of a particular electronic exchange or “thread” involving multiple participants and may therefore be appropriate for being organized with other messages of that exchange or thread.

With reference to block 304, the determination described above first involves determining if the incoming email message identifies an recipient of an email message that was transmitted via the email application 212 to multiple persons. For example, the manager 214 determines whether the sender or receiver of the received email message was a recipient included in a distribution list of the “To:” field (or equivalent, e.g., cc:, bcc:) of an original email message that the user transmitted. This determination is made with respect to a stored record of transmitted email messages.

For instance, the message organization manager 214 cross-references the sender email address with email addresses identified in transmitted email messages contained within a “Sent items” folder (or equivalent) to see if there is a match between the sender's email address and those contained within one or more email messages that were transmitted to multiple parties. By limiting the match determination to email messages that were sent to multiple parties, the determination is focused on email messages to which the user is likely to receive multiple replies from different persons.

Optionally, however, the match determination can be made with respect to other transmitted email messages to cover the situation in which an email message is sent to a single party who forwards the message to another, who then replies to the forwarded message and also sends a copy to the user who sent the original message. In such a case, the user can likewise receive multiple replies from multiple persons to an originally-transmitted email message. However, in the example method of FIG. 3, the determination is made only with respect to email messages that were transmitted to multiple persons.

With reference to block 306, if there is no match, the received email message is not pertinent to an email message that the user transmitted and, therefore, does not form part of an email exchange or thread involving multiple participants. In such a case, flow returns to block 300 at which monitoring for other received email messages continues. If, on the other hand, there is a match, the received email message may comprise part of such an exchange or thread and flow continues to block 308 at which the email message is scanned to determine whether it contains content that is common to both that email message and an originally-transmitted email message that was identified in block 304.

The content that is scanned depends upon the particular system implementation. In one such implementation, only the subject or title field (or equivalent) of the received email message is scanned for comparison with the content contained in the subject or title field of original email messages transmitted by the user. In such a case, the message organization manager 214 attempts to identify common character strings in that, if such common strings are identified, it is likely that the received email is relevant to an email message that was sent by the user. For example, if the received email message contains the content “RE: Proposed Meeting Schedule” in the subject line, and an email message that was transmitted by the user to the sender of the received message contained the content “Proposed Meeting Schedule” in its subject line, it may be presumed that the received email message is relevant to the original email message transmitted by the user.

In another more advanced implementation, the content contained within the body of the received email message is scanned for purposes of comparison with original transmitted email messages. In similar manner to the implementation described above, the content (this time from the message body) of the received email message is compared with content of email messages transmitted to the identified sender of the received message. From this comparison, the message organization manager 214 can likewise determine whether the received email message is relevant to the email message that was originally transmitted to that sender by the user.

Referring next to decision block 310, if there is no common content, or if the amount of common content does not exceed a predetermined threshold (e.g., only a few words, such as “a” or “the,” contained in the received email message correlate to words contained in a previously-transmitted email message), flow returns to block 300 and monitoring continues. If, however, the requisite amount of commonality exists, the email message is pertinent to a given transmitted email exchange involving multiple persons and flow continues down to block 312 at which the message organization manager 214 next compares the body of the received message with that of the original email message to identify content contained within the received message that was also contained in the original email message. In other words, the manager 214 identifies any text or other content of the original email message that has been reproduced (as is common practice) in the received email message.

The purpose for the comparison and identification identified above is to avoid the inclusion of redundant content in the consolidated message or other file that, as is described below, will be formed by the message organization manager 214. If this comparison/identification were not conducted, it is possible that the consolidated file would contain multiple copies of the content from the original email message that was sent by the user.

Once the common content has been identified, flow next continues to block 314 at which the message organization manager 214 organizes the responsive content, i.e. the content that was not contained in the original email message, in relation to the original transmitted content (i.e. from the original email message transmitted by the user) in a consolidated file. The nature and location of the consolidated file can be varied to suit the desired result. In one embodiment, the file can comprise an email message that is placed in the user's inbox. In such a case, the email message comprises a consolidated email message that contains all responsive content received in relation to the given original email message that the user transmitted. Therefore, the single consolidated email message can replace multiple email messages received from, for example, the various persons of the distribution list, thereby reducing the number of emails that must be reviewed. Special indicia (e.g., a specialized icon or other identifier) can be used to indicate to the user that the message is a consolidated email message that contains all responsive content pertinent to a given email exchange 15, or thread. Furthermore, other indicia can be provided each time new content has been added to the consolidated email message.

In another embodiment, a separate consolidated email message may be provided in a separate email folder. For instance, a “Consolidated messages” folder may be used to hold such email messages. In such a case, the original reply email 20 messages received from each individual may still be retained in the user's inbox as is common practice. However, indicia can be added to those original email messages to indicate to the user that a consolidated email message is available for review. Due to the availability of the consolidated email message, the user will have the option to either review each originally-received email message individually, or delete those emails and instead review the single consolidated email message.

In further embodiment, a separate consolidated file may be created that can be accessed in another portion of the email application 212 or in a separate application all together, such as a word processing application.

Irrespective of the location of the consolidated file, the responsive content from the received email message is organized within the file (e.g., email message) in some predetermined arrangement. The options available for this arrangement are many. In one such arrangement, the content is arranged by date and time received such that, as various responsive content from multiple persons is added to the file, the content will be arranged in a given chronological order (either oldest to newest or vice versa). Other arrangements include arranging the content alphabetically by sender name, by size of the content (e.g., number of words), by the seniority/priority of the sender, by the identified “importance” with which the responsive content was sent (e.g., “high,” “normal,” or “low” importance), or the like.

In addition to applying such arrangement “rules,” the responsive content can be arranged relative to the person to whom the sender is responding. For instance, if the user transmits an original email message to five recipients, and receives both direct replies and replies to one or more of those replies (in the case in which the direct replies where sent to “all”), the responsive content may further be arranged such that a given reply is closely associated with the reply to which it is responsive.

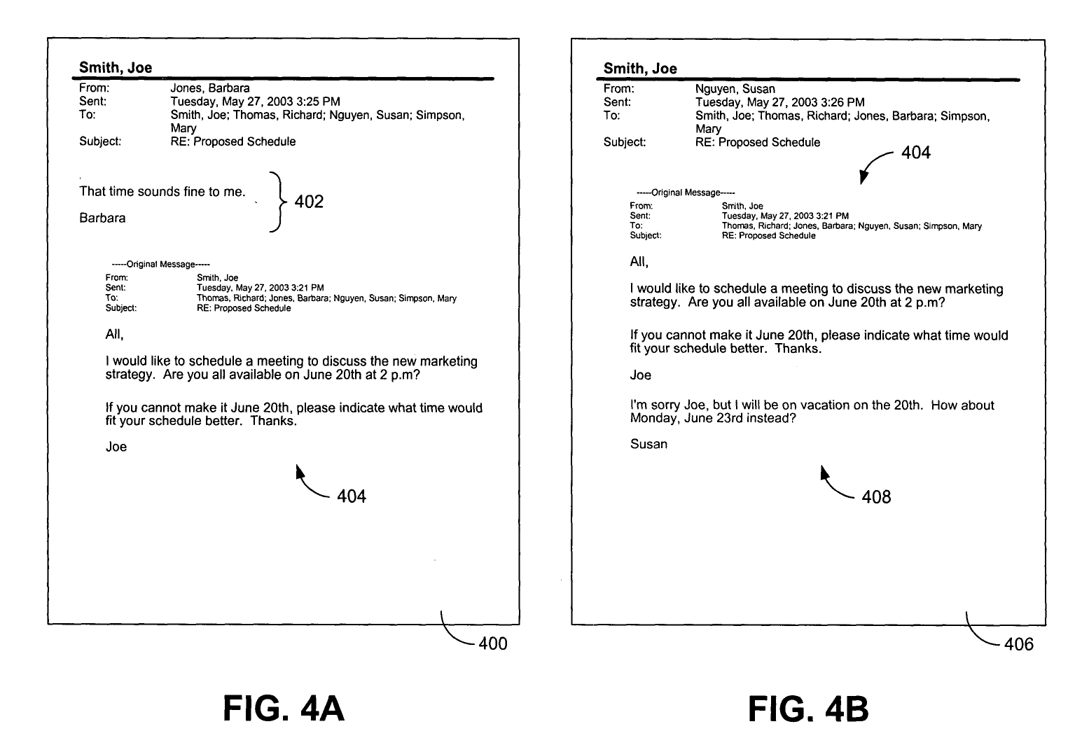

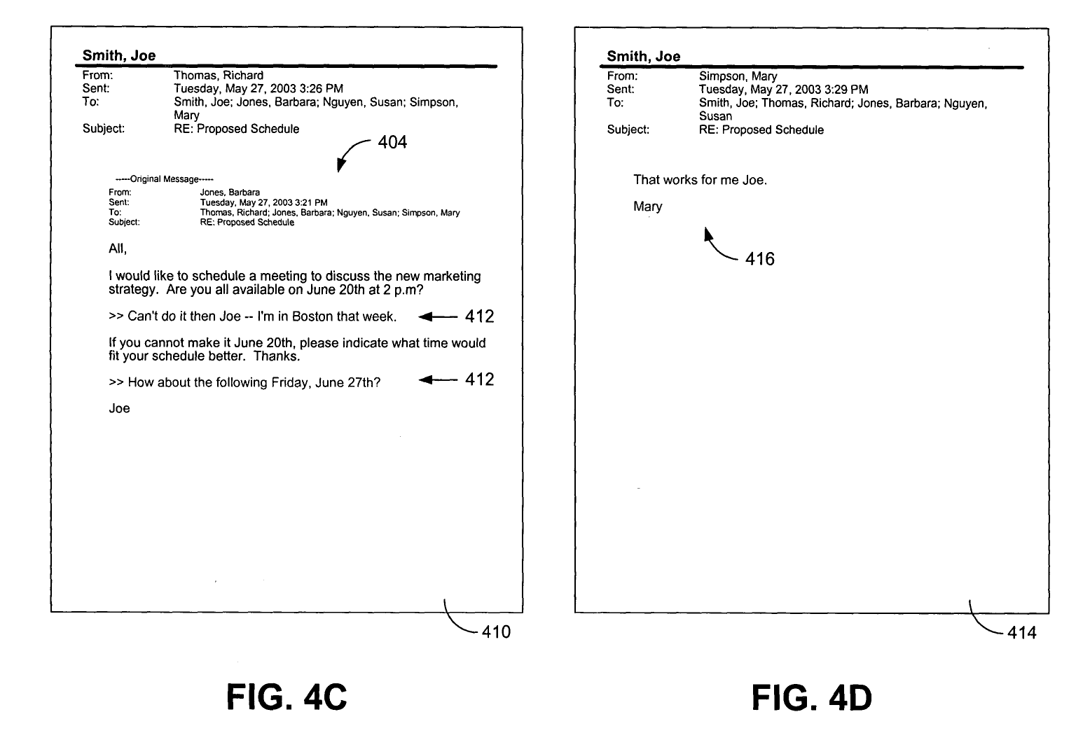

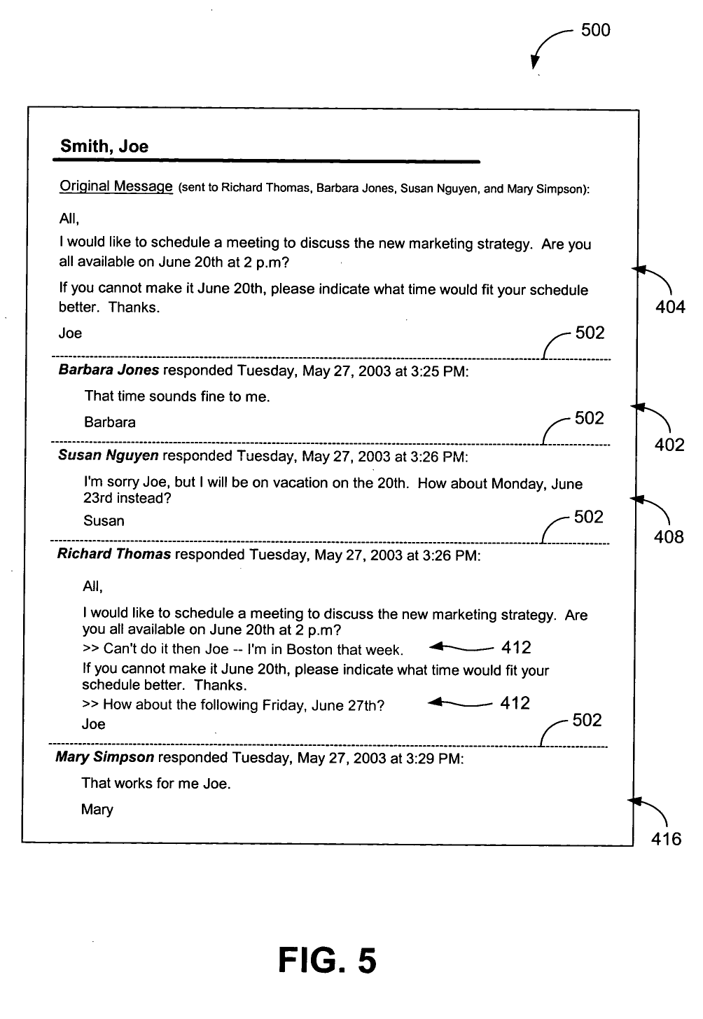

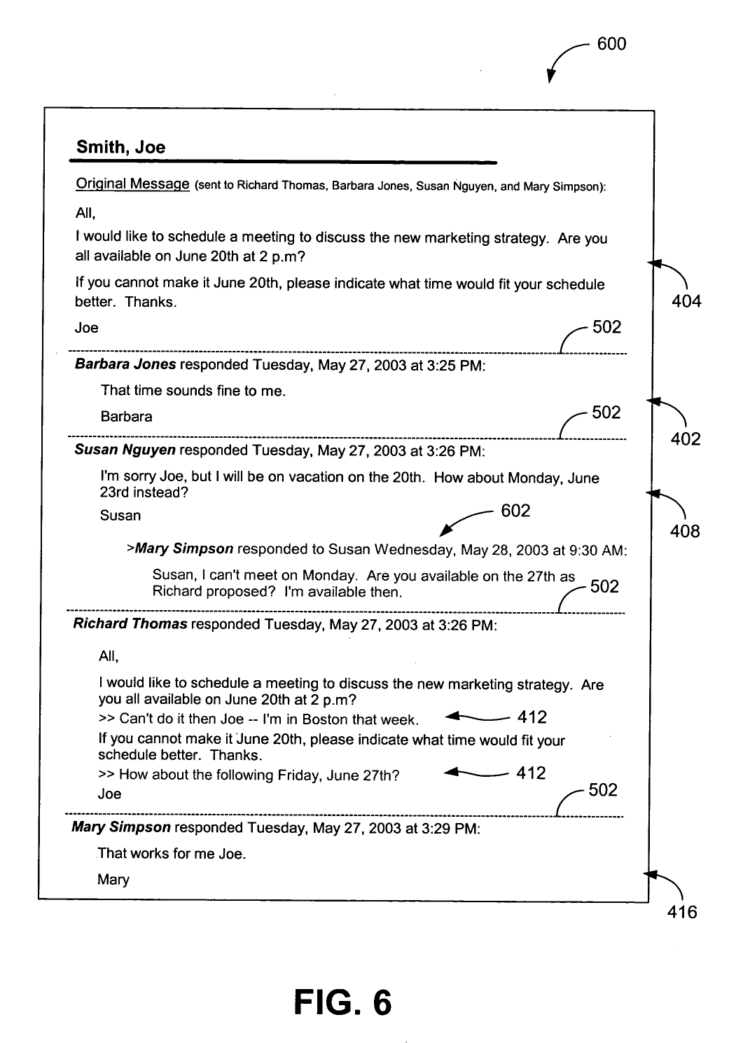

The above-described method can be more easily understood in view of specific examples. FIGS. 4-5 and FIG. 6 provide such examples. In particular, FIGS. 4A-4D illustrate example reply email messages that are received in response to an original email message transmitted by the user to multiple parties of a distribution list. FIG. 5 illustrates a first example consolidated email message that comprises content from each of the received email messages of FIGS. 4A-4D. Finally, FIG. 6 illustrates a second example consolidated email message. More specifically, FIG. 6 is an updated version of the consolidated email message of FIG. 5, and contains responsive content that was sent as a reply to another reply email message that was sent by another of the intended recipients.

Beginning with FIG. 4A, a reply email message or “reply” 400 has been received from “Barbara Jones.” As is apparent from FIG. 4A, the reply 400 was sent in response to an original email message sent by the user, “Joe Smith,” to Barbara as well as “Richard Thomas,” “Susan Nguyen,” and “Mary Simpson.” The reply 400 was sent to each of the above-noted persons (i.e. to each participant in the email exchange) and indicates that a meeting time proposed by Joe is acceptable to Barbara.

As shown in FIG. 4A, the reply 400 is arranged in a format in which the responsive content 402 provided by the sender (Barbara Jones) is provided at the top of the message in a distinct color (as indicated by a different line darkness in FIG. 4A), followed by the original message 404 to which the sender was replying.

FIG. 4B is a reply 406 that was received from Susan Nguyen. Like the reply 400, the reply 406 includes both new responsive content 408 and the original message 404 sent by the user, Joe Smith. In this example, however, the original message 404 is reproduced at the top of the reply 406 and is followed by the responsive content 408 of the sender, Susan Nguyen. As shown in FIG. 4B, the responsive content 408 is again provided in a different color than the original message to highlight the responsive content to the user. In this example, the sender (Susan Nguyen) indicates that the proposed meeting time is unacceptable and proposes an alternative meeting date.

FIG. 4C is a reply 410 that was received from Richard Thomas. In this reply 410, the responsive content 412 is intermingled with the original message 404, which has been reproduced for the user (Joe Smith). In particular, Richard has inserted specific responses to both of Joe's inquiries, one after each inquiry. As indicated in FIG. 4C, the specific responses are highlighted through use of a distinct color, and indicate that Richard cannot make the proposed meeting time. Instead, Richard has proposed another alternative meeting date.

Finally, FIG. 4D is a reply 414 that was received from Mary Simpson. In this reply 414, only the responsive content 416 is provided; the original message has not been reproduced. In her response, Mary indicates that the time proposed by the user, Joe Smith, is acceptable.

As is apparent from FIGS. 4A-4D, the sender of the original email message, Joe Smith, has received four replies from four different people. Therefore, Joe will now have four new emails in his inbox that he will need to open and read. Given the large number of email messages most individuals receive, the receipt of these multiple email messages is undesirable. Moreover, in that Joe is trying to schedule a meeting, he will need to keep track of everyone's responses as they are received. Joe could, for example, manually print out each of the responses and place them in a response folder in an attempt to organize them. Such a procedure may be necessary in situations in which far greater than four people were included in the distribution list of the original outgoing email message. However, such manual organization is also undesirable.

Using the systems and methods disclosed herein, however, Joe can, for example, receive a single email message that contains all communications that are responsive to Joe's originally-transmitted email message. An example of such an email message (i.e. a consolidated email message) is illustrated in FIG. 5.

As shown in FIG. 5, the consolidated email message 500 includes the original message 404 that the user, Joe Smith, had emailed to each of the intended recipients (i.e. Richard Thomas, Barbara Jones, Susan Nguyen, and Mary Simpson). After the original message 404, separated by dashed lines 502, is responsive content received from those recipients. In the example of FIG. 5, there is responsive content 402 from Barbara Jones, responsive content 408 from Susan Nguyen, responsive content 412 from Richard Thomas, and responsive content 416 from Mary Simpson. As can be appreciated through comparison of FIG. 5 to FIGS. 4A-4D, each of these content portions 400, 406, 410, and 414 pertain to the responsive content provided in the individual email replies.

The responsive content from Barbara, Susan, and Mary is provided by itself, i.e. without reproduction of the original message. This result is achieved due to the comparison/identification process described above in relation to block 312 of FIG. 3.

Because of that process, the amount of content that the user must parse and the amount of data that must be stored on the user's computing device (e.g., computing device 102) are reduced. In the case of the response from Richard Thomas, however, which was intermingled with the content of the originally-transmitted message, the original message content is reproduced along with the responsive content 412 to provide context for that responsive content. Although the original message content is shown as being reproduced in this manner, the intermingled responsive content 412 can instead be inserted into the original message 404 at the top of the email message 500. Alternatively, that content 412 can simply be produced by itself with an indication as to what portions of the original message 404 the responsive content 412 pertains. In the latter case, the indication can comprise, for instance, a numerical indication similar to footnotes used in formal written documents.

As can be appreciated from FIG. 5, the consolidation email message 500 can be used to reduce the number of email messages that a user receives in his or her inbox, thereby reducing the number of messages that must be reviewed. In addition, the consolidation email message 500 organizes the information in a manner that makes it much easier for the user to track the responses of multiple persons to an original email message that the user transmitted. In particular, the user need only refer to a single message (or other file) and can review all responses organized in a logical and intuitive order (e.g., chronological).

FIG. 6 illustrates a second example consolidated email message 600. This message 600 is an updated version of the consolidated email message 500 shown in FIG. 5. Specifically, the email message 600 includes new responsive content 602 that, in the example of FIG. 6, comprises a response from Mary Simpson to Susan Nguyen's response to Joe Smith's original email message. As is apparent from FIG. 4B, Susan's response was sent to each of the recipients of Joe's original email message (i.e. was sent to “all”). It is because of this reason that Mary received Susan's reply email message and could reply to it. Joe received Mary's response because, for example, Mary either provided a carbon copy to Joe or because Mary also sent her reply to “all.”

Irrespective of the manner in which the user, Joe, received the new responsive content 602, the content is organized in the consolidated email message 600 so as to be closely associated with Susan Nguyen's responsive content 408. Specifically, the new responsive content 602 is appended to Susan's responsive content 408 by being placed immediately after that content and by being indented relative to the content.

The new responsive content 602 is identified as being provided by “Mary Simpson” and, to highlight the new responsive content, the content is provided in a distinct color.

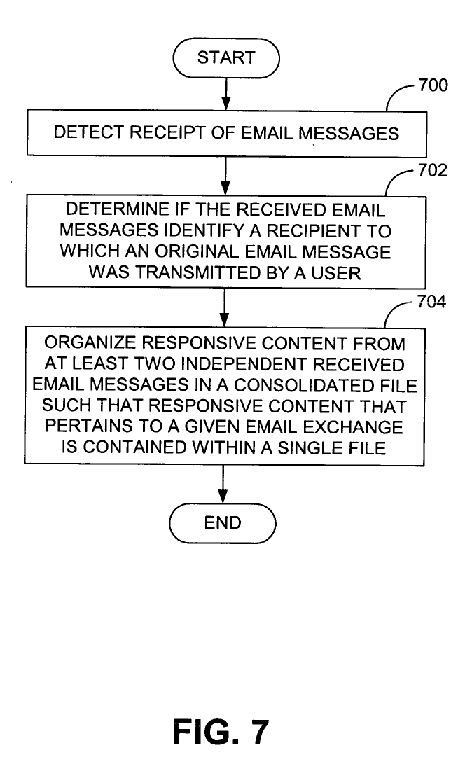

In view of the above disclosure, an embodiment for a method for organizing email messages can be summarized as indicated in FIG. 7. Beginning with block 700, receipt of email messages is detected. Next, it is determined if the received email messages identify an recipient to which an original email message was transmitted by the user, as indicated in block 702. Finally, responsive content from at least two independent received email messages is organized in a consolidated file such that responsive content that pertains to a given email exchange is contained within a single file, as indicated in block 704.

1. A method for organizing email messages received by a user, comprising:
detecting receipt of email messages;
determining if the received email messages identify a recipient to which an original email message was transmitted by the user; and
organizing responsive content from at least two independent received email messages in a consolidated file such that responsive content that pertains to a given email exchange is contained within a single file.

2. The method of claim 1, wherein determining if the received email messages identify a recipient comprises determining if senders of the received email messages were recipients to which the original email message was transmitted.

3. The method of claim 1, wherein organizing responsive content comprises organizing the responsive content from at least two independent received email messages that comprise direct responses to the original email message.

4. The method of claim 1, wherein organizing responsive content comprises organizing the responsive content relative to content of the original email message.

5. The method of claim 1, wherein organizing responsive content comprises comparing content contained within the received email messages with content contained within the original email message transmitted by the user to identify common content.

6. The method of claim 5, wherein organizing responsive content further comprises omitting the common content so as not to provide multiple copies of originally-transmitted content.

7. The method of claim 1, wherein organizing responsive content comprises organizing the responsive content in accordance with a date and time that the responsive content was received.

8. The method of claim 1, wherein organizing responsive content comprises organizing the responsive content in accordance with at least one of a sender name, a size of the responsive content, a priority of the sender, and an identified importance with which the responsive content was sent.

9. The method of claim 1, wherein organizing responsive content in a consolidated file comprises organizing the responsive content in a consolidated email message.

10. The method of claim 9, wherein organizing the responsive content in a consolidated email message comprises organizing the responsive content in a consolidated email message presented in an email application inbox in lieu of the independent incoming email messages.

11. The method of claim 1, further comprising organizing new content that is responsive to previously-organized responsive content in the consolidated file by associating the new content with the previously-organized responsive content.

12. A system for organizing email messages received by a user, comprising:
means for monitoring receipt of email messages;
means for detecting receipt of email messages;
means for determining if the received email messages were sent by a recipient to which an original email message was transmitted by the user; and
means for organizing responsive content from at least two of the independent received email messages sent by a recipient in a consolidated file such that all responsive content that pertains to a given email exchange is contained within a single file.

13. The system of claim 12, wherein the means for organizing responsive content comprise means for comparing content contained within the received email messages with content contained within the original email message transmitted by the user to identify common content, and further comprising means for omitting the common content so as not to provide multiple copies of originally-transmitted content.

14. The system of claim 12, wherein the means for organizing responsive content comprise means for organizing the responsive content in accordance with at least one of a date and time that the responsive content was received, a sender name, a size of the responsive content, a priority of the sender, and an identified importance with which the responsive content was sent.

15. The system of claim 12, wherein the means for organizing the responsive content comprise means for organizing the responsive content in a consolidated email message provided in an email application inbox in lieu of the independent incoming email messages.

16. The system of claim 12, further comprising means for organizing new content that is responsive to previously-organized responsive content in the consolidated file by associating the new content with the previously-organized responsive content.

17. A message organization manager stored on a computer-readable medium, the manager comprising:
logic configured to determine if received email messages identify an intended recipient to which an original email message was transmitted by the user; and
logic configured to organize responsive content from at least two independent received email messages that were determined to identify an intended recipient in a consolidated file such that all responsive content that pertains to a given email exchange is contained within a single file.

18. The manager of claim 17, wherein the logic configured to determine if the received email messages identify an intended recipient comprises logic configured to determine if senders of the received email messages were recipients to which the original email message was transmitted.

19. The manager of claim 17, wherein the logic configured to organize responsive content comprises logic configured to compare content contained within the received email messages with content contained within the original email message to identify common content, and further comprising logic configured to omit the common content.

20. The manager of claim 17, wherein the logic configured to organize responsive content comprises logic configured to organize the responsive content in accordance with a date and time that the responsive content was received.

21. The manager of claim 17, wherein the logic configured to organize responsive content comprises logic configured to organize the responsive content in accordance with at least one of a sender name, a size of the responsive content, a priority of the sender, and an identified importance with which the responsive content was sent.

22. The manager of claim 17, wherein the logic configured to organize responsive content in a consolidation file comprises logic configured to organize the responsive content in a consolidated email message that is provided in an email application inbox in lieu of the independent incoming email messages.

23. The manager of claim 17, further comprising logic configured to organize new content that is responsive to previously-organized responsive content in the consolidated file by associating the new content with the previously-organized responsive content.
